(19) United States
(12) Patent Application Publication
(10) Pub. No.: US 2011/0317876 A1
(43) Pub. Date: Dec. 29, 2011

(54) Optical Control System for Heliostats

(76) Inventor: William H. Bender, Norwich, VT (US)

(21) Appl. No.: 13/167,098

(22) Filed: Jun. 23, 2011

Related U.S. Application Data
(60) Provisional application No. 61/357,883, filed on Jun. 23, 2010.

(51) Int. Cl. G06K 9/00

(52) U.S. Cl. 382/103

(57) ABSTRACT

A method of aligning a reflector with a target includes receiving, at a first reflector, light from a light source. The first reflector is configured to reflect light from the light source onto a target, illuminating the target in a first target region. A first image of the target is captured, using an imaging device. The first reflector is configured to reflect light from the light source onto the target, illuminating the target in a second target region. A second image of the target is captured, using the imaging device. The differences between the first image and the second image are compared to determine the alignment of the first reflector with respect to at least one of the light source and the target.

### CROSS-REFERENCE TO RELATED APPLICATIONS

This application claims priority from provisional application 61/357,883, Optical Control System for Heliostats, filed Jun. 23, 2010.

### TECHNICAL FIELD

This disclosure relates to control of reflectors, and, more particularly, to optical control of reflectors, including heliostats.

### BACKGROUND

Historically, a large portion of electric and heating power has been generated through non-renewable means such as the burning of fossil fuels. Because of the finite nature of these sources and the volatile price fluctuations they may exhibit, it is desirable to obtain electric and heating power from more renewable and non-volatile sources. Accordingly, there has been significant growth in the use of solar power both to generate electricity and to provide a heat for residential, commercial and industrial uses.

Because of the diffuse nature of the solar resource, it is often desirable to concentrate the rays of the sun. This is sometimes accomplished through the use of reflectors, which direct sunlight from a wide area onto a smaller target, effectively concentrating the sunlight for more efficient use. The more accurately sunlight can be directed onto the desired target, the greater the efficiency with which the energy of the sunlight can be used. However, due to the presence of clouds, wind and other weather elements, as well as other factors, it can be both difficult and expensive to maintain accurate alignment between reflectors and targets. Accordingly, a method is needed which may allow for accurate alignment without expensive equipment.

### SUMMARY OF DISCLOSURE

According to a first aspect of the disclosure, a method for aligning a reflector with a target includes receiving, at a first reflector, light from a light source. The first reflector is configured to reflect light from the light source onto a target, illuminating the target in a first target region. A first image of the target is captured, using an imaging device. The first reflector is configured to reflect light from the light source onto the target, illuminating the target in a second target region. A second image of the target is captured, using the imaging device. An alignment of the first reflector with respect to at least one of the light source and the target is determined by, at least in part, comparing the first image and the second image.

One or more of the following features may be included. Light from a light source may be received at a second reflector. The second reflector may be configured to reflect light from the light source onto the target, illuminating the target in a third target region. A third image of the target may be captured, using the imaging device. The second reflector may be configured to reflect light from the light source onto the target, illuminating the target in a fourth target region. A fourth image of the target may be captured, using the imaging device. An alignment of the second reflector with respect to at least one of the light source and the target may be determined by, at least in part, comparing the third image and the fourth image.

A centroid may be determined of at least one the first target region and the second target region. A fringe portion may be identified of at least one of the first target region and the second target region. A vibration of the first reflector may be generated. At least one of a time to capture at least one of the first image and the second image and a location of a portion of at least one of the first target region and the second target region may be determined, based at least in part on the vibration of the first reflector. A location of the first reflector may be determined. A geometrical characteristic of the first reflector may be determined. A portion of at least one of the first target region and the second target region may be identified, based, at least in part, on at least one of the location of the first reflector and the geometrical characteristic of the first reflector. The imaging device may include at least one or more of a digital camera and a digital video camera.

According to another aspect of the disclosure, a system for aligning a reflector with a target includes a first reflector, configured to receive light from a light source, a target, and an imaging device. The first reflector is configured to reflect light from the light source onto the target, illuminating the target in a first target region. A first image of the target is captured, using the imaging device. The first reflector is configured to reflect light from the light source onto the target, illuminating the target in a second target region. A second image of the target is captured, using the imaging device. An alignment of the first reflector with respect to at least one of the light source and the target is determined by, at least in part, comparing the first image and the second image.

One or more of the following features may be included. A second reflector may be configured to receive light from a light source. The second reflector may be configured to reflect light from the light source onto the target, illuminating the target in a third target region. A third image of the target may be captured, using the imaging device. The second reflector may be configured to reflect light from the light source onto the target, illuminating the target in a fourth target region. A fourth image of the target may be captured. An alignment of the second reflector with respect to at least one of the light source and the target may be determined by, at least in part, comparing the third image and the fourth image.

A centroid may be determined of at least one the first target region and the second target region. A fringe portion may be identified of at least one of the first target region and the second target region. A vibration of the first reflector may be generated. At least one of a time to capture at least one of the first image and the second image and a location of a portion at least one of the first target region and the second target region may be determined, based at least in part on the vibration of the first reflector. A location of the first reflector may be determined. A geometrical characteristic of the first reflector may be determined. A portion of at least one of the first target region and the second target region may be identified, based, at least in part, on at least one of the location of the first reflector and the geometrical characteristic of the first reflector. The imaging device may include at least one or more of a digital camera and a digital video camera.

According to another aspect of the disclosure, a control system for aligning a reflector with a target, includes a reflector, configured to receive light from a light source, a target, at least one processor, and an imaging device. The reflector is configured to reflect light from the light source onto a target, illuminating the target in a first target region. A first image of the target is captured, using the imaging device. The reflector is configured to reflect light from the light source onto the target, illuminating the target in a second target region. A second image of the target is captured, using the imaging device. The at least one processor is configured to determine a first alignment of a reflector with respect to at least one of the light source and the target by, at least in part, comparing the first image and the second image, determine a deviation between the first alignment of the reflector and a target alignment of the reflector, and configure a second alignment of the reflector based at least in part on the deviation between the first alignment of the reflector and the target alignment of the reflector.

According to another aspect of the disclosure, a method for aligning a reflector with a target includes receiving light from a light source at a reflector. The reflector is configured to reflect light from the light source onto a target, illuminating the target in a target region. An image of the target is captured, using an imaging device. A location of a portion of the target region is determined by, at least in part, analyzing the image. A first alignment of the reflector with respect to at least one of the light source and the target is determined, based at least in part on the location of the portion of the target region. A second alignment of the reflector is configured, based at least in part on a deviation between the first alignment of the reflector and a target alignment of the reflector.

One or more of the following features may be included. A centroid of the target region may be determined. A fringe portion of the target region may be identified. A vibration of the reflector may be generated. At least one of a time to capture the image and the location of the portion of the target region may be identified, based at least in part on the vibration of the reflector. A location of the reflector may be determined. A geometrical characteristic of the reflector may be determined. The portion of the target region may be identified, based at least in part on at least one of the location of the reflector and the geometrical characteristic of the reflector. The imaging device may include at least one or more of a digital camera and a digital video camera.

According to another aspect of the disclosure, a system for aligning a reflector with a target includes a reflector, configured to receive light from a light source, a target, at least one processor, and an imaging device. The reflector is configured to reflect light from the light source onto a target, illuminating the target in a target region. An image of the target is captured, using the imaging device. The at least one processor is configured to determine a location of a portion of the target region by, at least in part, analyzing the image, determine a first alignment of the reflector with respect to at least one of the light source and the target, based upon, at least in part, the location of the portion of the target region, and configure a second alignment of the reflector, based upon, at least in part, a deviation between the first alignment of the reflector and a target alignment of the reflector.

One or more of the following features may be included. A centroid of the target region may be determined. A fringe portion of the target region may be indentified. A vibration of the reflector may be generated. At least one of a time to capture the image and the location of the portion of the target region may be determined, based at least in part on the vibration of the reflector. A location of the reflector may be determined. A geometrical characteristic of the reflector may be determined. The portion of the target region may be identified, based at least in part on at least one of the location of the reflector and the geometrical characteristic of the reflector. The imaging device may include at least one or more of a digital camera and a digital video camera.

### BRIEF DESCRIPTION OF THE DRAWINGS

FIG. 1 is a flow chart of a process implemented by an optical control system for heliostats; and

FIG. 2 is a diagrammatic view of an implementation of the optical control system for heliostats of FIG. 1.

FIG. 3 diagrammatically depicts various views of a target, for various implementations of the optical control system for heliostats of FIG. 1.

Like reference symbols in the various drawings indicate like elements.

### DETAILED DESCRIPTION OF THE PREFERRED EMBODIMENTS

On a clear day approximately 1000 W/m² of incident solar radiation may reach the earth's surface. This represents a vast potential energy source for a variety of activities, including generation of electricity and the harvesting of process heat. For example, incident solar radiation may be captured with photovoltaic cells, which directly convert the sunlight into electricity. The energy of the radiation may also be captured as heat through various methods. Examples of this include hot water arrays on residential and commercial buildings, industrial installations for heating water or other working fluids, and “power tower” installations. In a power tower installation, an array of heliostats, which may include adjustable minors (e.g., a single mirror or a plurality of minors arranged in a pattern) for reflecting solar radiation, reflects the incident solar radiation from a large area onto a smaller, often elevated, target. The convergence of this solar radiation on the target can result in very high temperatures, often between 900° and 1900° F., which may be sufficient to operate a known thermodynamic cycle and generate electricity.

In general, systems that reflect or otherwise harvest sunlight from a larger area and focus it on a smaller area to facilitate heating, electricity generation or other useful tasks are referred to as “concentrated solar” systems. As noted, these systems may sometimes be directed toward the generation of electricity and may also sometimes be directed toward the harvesting of useful heat for industrial or other processes.

The working fluid for concentrated solar systems may vary depending on the purpose of the system. For example, a power tower system configured to generate electricity may employ water as a working fluid, operating a steam cycle. A power tower system may also, for example, employ salt, made molten by the concentrated solar energy, or supercritical carbon dioxide. Concentrated solar systems may also sometimes employ air or other gases, for example, for use in a Brayton-cycle system.

In other configurations, concentrated solar systems may employ water as a working fluid for purposes other than the generation of electricity. For example, residential and commercial systems may harvest solar energy in order to supply hot water for individual or other uses. Industrial installations may also sometimes use concentrated solar systems to heat water (or other fluids) for use in various industrial processes.

The number of reflectors employed in a concentrated solar system may vary considerably depending on the purpose of the system. For example, small process-heat systems may employ only a few reflectors, while industrial-scale process-heat systems may employ tens or hundreds of reflectors. A typical Brayton-cycle system may employ between 45 and 500 reflectors, depending on the size of the turbine, and large power tower installations, for example a 1000 MW power plant, may employ over 100,000 reflectors.

One aspect related to concentrated solar systems is the alignment of the heliostat, or other reflector, with the target of the system. The target, as referenced above, may include a thermal receiver of various types, configured to receive the concentrated solar energy and transfer a portion of that energy to the working fluid. It may be desirable that the heliostats or other reflectors accurately reflect sunlight onto the target, as sunlight that is not directed accurately onto the target may represent lost energy. Further, because, with respect to a fixed location on the earth, the sun moves continuously throughout the day and its orientation also changes from day to day, reflectors may need to be frequently or continuously adjusted in order to assure accurate alignment with the target. In some systems, the alignment of reflectors may be updated as often as every 20 to 25 seconds and may employ adjustments of more or less than 1/20 of a degree.

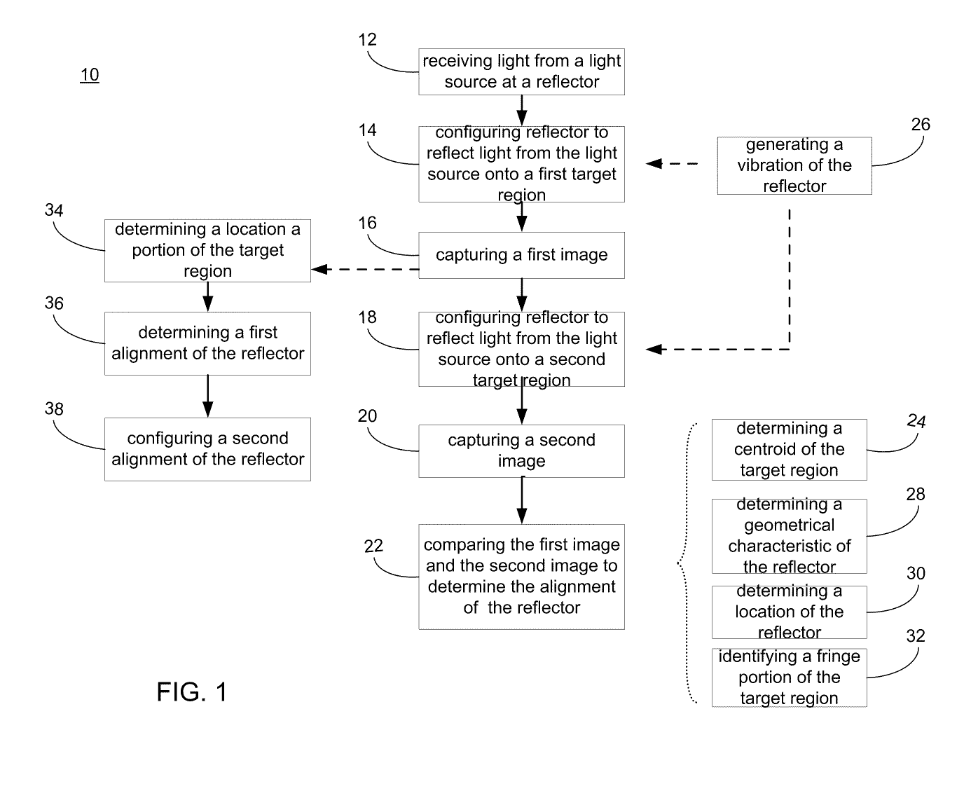

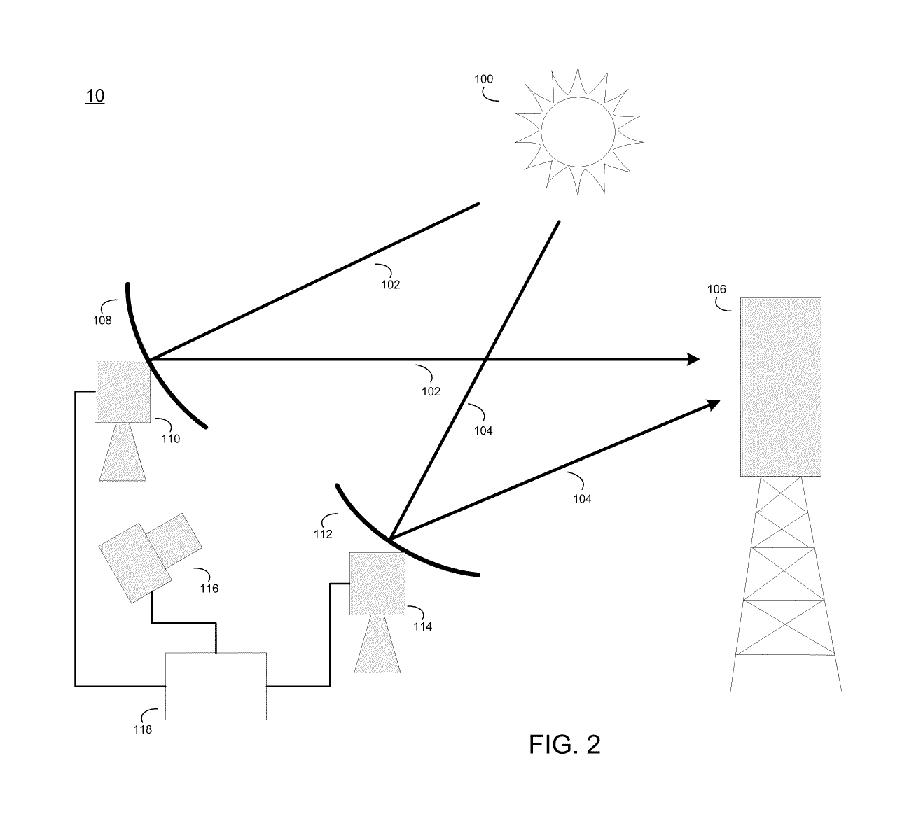

Referring to FIGS. 1 and 2, there is shown one implementation of a method (i.e., method 10) of aligning a reflector with a target. The method may include receiving 12, at first reflector 108, light 102 from light source 100. Light source 100 may include the sun. First reflector 108 may include a heliostat and may be mounted, for example, on assembly 110, which may include equipment for connecting first reflector 108 to a motor, motor assembly or other suitable actuator so that its alignment may be adjusted. First reflector 108 may include for example, but is not limited to, a flat or a parabolic mirror. First reflector 108 may include multiple smaller minors, assembled to approximate one larger flat or parabolic minor, as is well known in the art. Assembly 110 may also include control electronics (not shown), including various control circuits, processors, and microprocessors. Assembly 110 or first reflector 108 may also be connected to a remote control system, including, for example, but not limited to, processor 118. The connection between assembly 110 or first reflector 108 and the remote control system may include, for example, Ethernet or coaxial connections or wireless connections using, for example, equipment configured to utilize the IEEE 801.11 standard, as is known in the art. First reflector 108 may be controlled by various types of control systems, for example a dead reckoning system (e.g., a system in which the proper alignment of the reflector is calculated based on the precise location of the reflector, the date and the exact time), a sun tracking system (e.g., a system in which a sensor directly determines the position of the sun with respect to the reflector), or a counter system (e.g., a system in which an electronic counter determines the relative movement of a reflector from a previous alignment), such that it may be adjusted at specified intervals to change its relative alignment. This control may include, for example, adjustments of azimuth orientation at approximately 25 second intervals and adjustments of altitude orientation at intervals of between approximately 25 seconds and 30 minutes. It will be understood in the art that altitude orientation may refer to the angle formed between a line normal to a reflector and a line parallel to the earth at the location of a reflector. It will also be understood in the art that azimuth orientation may refer to the angle formed between a reflector, a reference point and the projection onto a reference plane of a point of interest, where the reference plane may be a plane parallel to the earth at the location of a reflector.

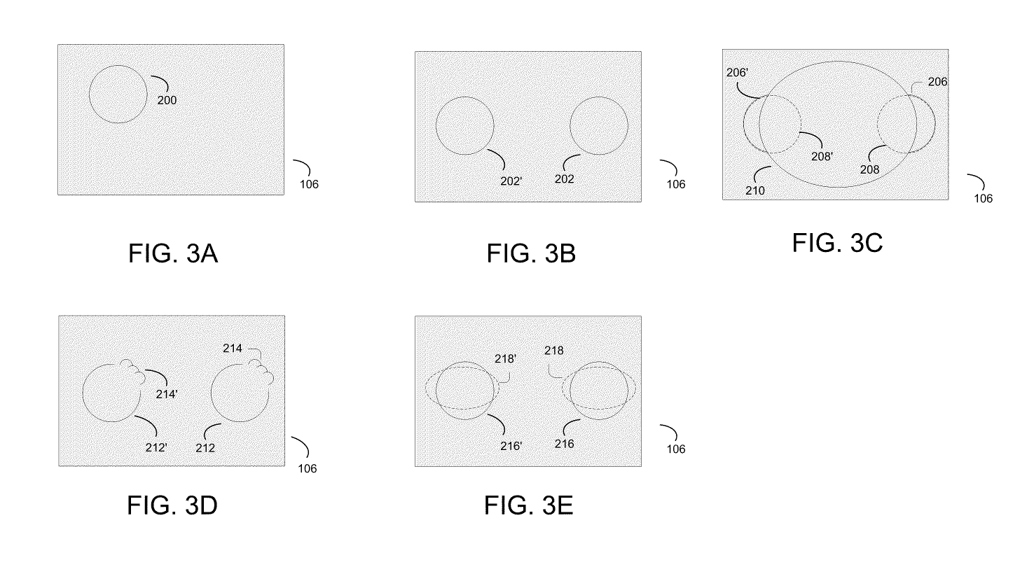

Referring now also to FIG. 3B, method 10 may include configuring 14 first reflector 108 to reflect light 102 from light source 100 onto target 106. Target 106 may be in thermal communication with a working fluid or an industrial, commercial or residential process that requires heat. Target 106 may be the principle target for a concentrated solar system. In this way, as will become clear from the discussion herein, because first reflector 108 (or another reflector) may not need to be aligned away from target 106 during method 10, first reflector 108 (or another reflector) may be aligned with target 106 without the loss of heating power that may occur in a conventional “alignment target” system (e.g., a system in which a reflector is directed towards an alignment target, which is separate from the principle system target, for the purpose of aligning the reflector). Light 102 reflected from light source 100 onto target 106 by first reflector 108 may illuminate the target in first target region 202. First target region 202 is depicted in FIG. 3B as a perfect circle, but it may also include other geometrical shapes. For example, imperfections on first reflector 108, fouling from dirt or animals or other effects may result in first target region 202 exhibiting irregular edges or varying levels of brightness.

Method 10 may further include capturing 16 a first image, using imaging device 116, wherein the first image includes a first image of target 106. The amount of time between configuring 14 first reflector 108 and capturing 16 a first image may be known. The relative movement of the sun over this amount of time, with respect to first reflector 108, may be determined based on this amount of time, as is known in the art. Preferably, the first image of target 106 may include the image of at least a portion of first target region 202. The first image of target 106 may include the image of the entire target 106. Imaging device 116 may include various imaging devices known in the art, including, for example digital cameras or digital video cameras. Imaging device 116 may include a data storage device capable of storing images (not shown). Imaging device 116 may also include, for example, various means for transferring data from imaging device 116 to a computing device (e.g., processor 118). These means for transferring data may include, for example, Ethernet or other wired connection or equipment configured to utilize wireless communication, as is known in the art.

First reflector 108 may then be configured 18 to reflect light 102 from light source 100 onto target 106, in such a way as to illuminate target 106 in second target region 202′. This may occur a known amount in time following the capturing 16 of the first image. The relative movement of the sun with respect to first reflector 108 may be determined based on this amount of time. Second target region 202′ is depicted in FIG. 3B as a perfect circle, but it may also include other geometrical shapes. For example, imperfections on first reflector 108, fouling from dirt or animals or other effects may result in second target region 202′ exhibiting irregular edges or varying levels of brightness. It will be understood that second target region 202′ may be similar or identical in shape to other target regions or may differ in shape from other target regions in a variety of ways.

A second image may be captured 20, using imaging device 116, wherein the second image includes a second image of the target 106. The amount of time between configuring 18 first reflector 108 and capturing 20 a second image may be known. The relative movement of the sun over this amount of time, with respect to first reflector 108, may be determined based on this amount of time. The second image of target 106 may include the image of at least a portion of second target region 202′. The second image of target 106 may include the image of the entire target 106. Imaging device 116 may include various imaging devices known in the art, including, for example digital cameras or digital video cameras. It will be understood that the first image and second image may be captured by a single imaging device 116 or by multiple imaging devices (not shown) and that it may not be necessary to capture the first image and the second image on the same imaging device.

Method 10 may further include comparing 22 the first image and the second image to determine the alignment of first reflector 108 with respect to at least one of light source 100 and target 106. Comparing 22 the first image and the second image may include comparing the differences between the first image and the second image. The first image and the second image may be compared by, for example, processor 118. As is known in the art, this may be accomplished by, for example, assigning a numerical value to the brightness of each pixel of the first and second images and subtracting the values of the second image from the values of the first image in order to determine the changes in brightness between the images. From this change, the relative translation of light 102 reflected onto target 106 by first reflector 108, between the time of the first image and the time of the second image may be determined. Because first reflector 108 may be configured to reflect light 102 onto first target region 202 for the first image and onto second target region 202′ for the second image, the changes in brightness between the images may be used to determine the alignment of first reflector 108 with respect to at least one of light source 100 and target 106. It will be understood that various other calculation methods may be employed to determine the differences between the first and second images or otherwise compare the first and second images, as is well known in the art.

It will be understood that processor 118 may be connected, for example, to assembly 110, assembly 114, imaging device 116, and target 106. Processor 118 may include various types of computing devices, including, but not limited to, a personal computer, a laptop computer, a notebook computer, a server computer, and a microprocessor, and may be connected to components of a system in various ways, for example with Ethernet, coaxial or other wired connections, or through a wireless communication link (not shown).

It will also be understood that capturing 20 a second image may not always be necessary in order to determine the alignment of first reflector 108. For example, as indicated by the dotted arrow in FIG. 1, method 10 may include, subsequent to capturing 16 a first image, identifying 34 the location of the target region. Identifying the location of the target region may be accomplished by analyzing the image. Referring now also to FIG. 3A, reflector 108 may be configured 14 to reflect light 102 from light source 100 onto target region 200 of target 106. An image may be captured 16, using imaging device 116, wherein the image may include the image of at least a portion of target region 200. The image of target 106 may include the image of the entire target 106. It will be understood that the location of target region 200 on target 106 may determined from the first image in various ways that are well known in the art including, for example, by comparing the relative brightness of the various pixels of the first image with a known or predicted approximate brightness or shape of target region 200. Various machine vision methods, as are well known in the art, may be implemented to determine the location of the image of target region 200 in the image of target 106. Using known principles of geometry a first alignment of reflector 108 may be determined 36, based at least in part on the location of target region 200 in the image of target 106.

A second alignment of reflector 108 may be configured, based at least in part on a deviation between the first alignment of reflector 108 and a target alignment of reflector 108. The target alignment of reflector 108 may be determined, for example, based on the desired location of target region 200 on target 106. The target alignment of reflector 108 may also be determined, for example, based on the known location of reflector 108 and target 106 as well as the location of light source 100, which may be known or predicted based in part on the current date and time. The second alignment of reflector 108 may be approximately equivalent to the target alignment of reflector 108. The reflector 108 may be configured to the second alignment through known means, for example, by communicating instructions to motors in assembly 110 that result in configuration of reflector 108 to the second alignment.

Method 10 may further include determining the alignment of second reflector 112. Second reflector 112 may include a heliostat and may be mounted, for example, on assembly 114, which may include equipment for connecting second reflector 112 to a motor, motor assembly, or other suitable actuator. Second reflector 112 may include for example, but is not limited to, a flat or a parabolic minor. Further, second reflector 112 may include multiple smaller mirrors, assembled to approximate one larger flat or parabolic mirror. Assembly 114 may also include control electronics (not shown), including various control circuits, processors, and microprocessors. Assembly 114 or second reflector 112 may also be connected to a remote control system, including, for example, but not limited to, processor 118. The connection between assembly 114 or second reflector 112 and the remote control system may include, for example, Ethernet or coaxial connections or wireless connections using, for example, equipment configured to utilize the IEEE 801.11 standard, as is known in the art. Second reflector 112 may be controlled by various types of control systems, for example a dead reckoning system, a sun tracking system, or a counter system, such that it is adjusted at specified intervals to change its relative alignment. This control may include, for example, adjustments of azimuth orientation at approximately 25 second intervals and adjustments of altitude orientation at intervals of between approximately 25 seconds and 30 minutes

Referring now also to FIG. 3D, method 10 may include configuring 14 second reflector 112 to reflect light 104 from light source 100 onto target 106. Light 104 reflected from light source 100 onto target 106 by second reflector 112 may illuminate the target in third target region 212. Third target region 212 is depicted in FIG. 3D as a circle with irregularity 214, but it may also include other geometrical shapes and may include no irregularity. Irregularity 214 may result from imperfections on second reflector 112, fouling from dirt or animals or other effects and may result in third target region 212 exhibiting irregular edges or varying levels of brightness. It will be understood that third target region 212 may be similar or identical in shape to other target regions or may differ in shape from other target regions in a variety of ways.

Method 10 may further include capturing 16 a third image, using imaging device 116, wherein the third image includes a third image of target 106. The amount of time between configuring 14 second reflector 112 and capturing 16 a third image may be known. The relative movement of the sun over this amount of time, with respect to second reflector 112, may be determined based on this amount of time. The third image of target 106 may include the image of at least a portion of third target region 212. The third image of target 106 may include the image of the entire target 106. Imaging device 116 may include various imaging devices known in the art, including, for example digital cameras or digital video cameras. Imaging device 116 may include a data storage device capable of storing images (not shown). Imaging device 116 may also include, for example, various means for transferring data from imaging device 116 to a computing device (e.g., processor 118). These means for transferring data may include, for example, Ethernet or other wired connection or equipment configured to utilize wireless communication, as is known in the art.

Second reflector 112 may then be configured 18 to reflect light 104 from light source 100 onto target 106, in such a way as to illuminate target 106 in fourth target region 212′. This may occur a known amount in time following the capturing 16 of the first image. The relative movement of the sun with respect to second reflector 112 may be determined based on this amount of time. Fourth target region 212′ is depicted in FIG. 3D as a circle with irregularity 214′, but it may also include other geometrical shapes and may include no irregularity. Irregularity 214′ may result from imperfections on second reflector 112, fouling from dirt or animals or other effects and may result in fourth target region 212′ exhibiting irregular edges or varying levels of brightness. It will be understood that fourth target region 212′ may be similar or identical in shape to other target regions or may differ in shape from other target regions in a variety of ways.

A fourth image may be captured 20, using imaging device 116, wherein the fourth image includes a fourth image of the target 106. The amount of time between configuring 18 second reflector 112 and capturing 20 a fourth image may be known. The relatively movement of the sun over this amount of time, with respect to second reflector 112, may be determined based on this amount of time. The fourth image of target 106 may include the image of at least a portion of fourth target region 202′. The fourth image of target 106 may include the image of the entire target 106. Imaging device 116 may include various imaging devices known in the art, including, for example digital cameras or digital video cameras. It will be understood that the third and fourth image may be captured by a single imaging device 116 or by multiple imaging devices (not shown) and that it may not be necessary to capture the first image and the second image on the same imaging device. It will further be understood that a single imaging device 116 may be employed for alignment of multiple reflectors—e.g., first reflector 108 and second reflector 112—or multiple imaging devices (not shown) may be employed for alignment of multiple reflectors.

Method 10 may further include comparing 22 the third image and the fourth image to determine the alignment of second reflector 112 with respect to at least one of light source 100 and target 106. Comparing 22 the third image and the fourth image may include comparing the differences between the first image and the second image. The third image and the fourth image may be compared by, for example, processor 118. As is known in the art, this may be accomplished by, for example, assigning a numerical value to the brightness of each pixel of the third and fourth images and subtracting the values of the fourth image from the values of the third image in order to determine the changes in brightness between the images. From this change, the relative movement of light 104 reflected onto target 106 by second reflector 112, between the time of the third image and the time of the fourth image may be determined. Because second reflector 112 may be configured to reflect light 104 onto third target region 202 for the third image and onto fourth target region 202′ for the fourth image, the changes in brightness between the images may be used to determine the alignment of second reflector 112 and at least one of light source 100 and target 106. It will be understood that various other calculation methods may be employed to determine the differences between the third and fourth images or otherwise compare the third and fourth images, as is well known in the art.

It will be understood that processor 118 may be connected, for example, to assembly 110, assembly 114, imaging device 116, and target 106. Processor 118 may include various types of computing devices, including, but not limited to, a personal computer, a laptop computer, a notebook computer, a server computer, and a microprocessor, and may be connected to components of a system in various ways, for example with Ethernet, coaxial or other wired connections, or through a wireless communication link (not shown).

Method 10 may further include various methods for determining the various alignments of a reflector. For example, method 10 may include determining 24 a centroid of first target region 202. A centroid may generally include the geometric center of a figure or shape and can be determined using various well-known methods.

Referring now also to FIG. 3C, method 10 may also include identifying 32 fringe portion 206 of first target region 208 and fringe portion 206′ of second target region 208′. This may be particularly useful when multiple reflectors—e.g., first reflector 108 and second reflector 112—are configured to reflect light from light source 100 onto target 106. The incidence on target 106 of reflected light from multiple reflectors may result in area of light 210 on target 106 that makes determining the location of first target region 208 or of second target region 208′, for example, difficult. This is because the relatively small amount of light from a single reflector (e.g., first reflector 108) may be visually overwhelmed by the total amount of light from all reflectors. This is indicated by dotted lines in the portion of, for example, first target region 208 that overlaps with area 210. In the case that first fringe portion 206 of first target region 208 or second fringe portion 206′ of second target region 208′ may be seen, at least one of these fringe portions may be identified, in order to assist in determining the location of a target region (e.g., first target region 208 or the second target region 208′). In an installation employing multiple reflectors, it may further be possible to stagger the adjustment of the multiple reflectors, which adjustment is necessary in order to track the sun across the sky, so that a limited number of fringes (e.g., only first fringe portion 206 or second fringe portion 206′) may be visible in the first or second image.

As another example, method 10 may include generating 26 a vibration of, for example, first reflector 108. This vibration may result from natural occurrences including, for example, wind or other weather elements. This vibration may also result from mechanical means. For example, the activation of a motor in assembly 110 may cause first reflector 108 to vibrate at a particular frequency. As a result, the projection of light from first reflector 108 onto target 106 (e.g., first target region 208) may oscillate on target 106 at a particular frequency. This vibration may be useful, for example, in identifying the location of first target region 208, by identifying the portion of light projected onto target 106 which oscillates in a manner corresponding to the vibration of first reflector 108. This vibration may be further useful in identifying 32 a fringe portion of reflected light, for example, first fringe portion 206. As the location of first target region 208 oscillates on target 106, due to the vibration of first reflector 108, first fringe portion 206 may also oscillate, moving alternately further outside of and further inside of area 210. A first image may be captured, for example, at the time when first fringe portion 206 has moved further outside of area 210, for example when first fringe portion 206 is maximally outside of area 210. This may be particularly useful when area 210 is particularly large or particularly bright, because of the incidence of light from multiple reflectors.

As another example, method 10 may include determining 28 a location of first reflector 108. The location of first reflector 108 may be determined 28 using various methods known in the art. For example, standard Global Positioning Systems (GPS) techniques may be employed to determine the precise latitude and longitude of first reflector 108. As another example, a separate imaging device (not shown) may be used along with, for example, a machine vision algorithm, to determine the location of first reflector 108. The location of first reflector 108 may, at least in part, determine the shape of the projection of light reflected from first reflector 108 onto target 106. Referring now also to FIG. 3E, first reflector 108, for example, may be located in a western portion of a concentrated solar array and second reflector 112 may be located in an eastern portion of a concentrated solar array, which may result in the light reflected by first reflector 108 onto target 106 projecting a different shape (e.g., first target region 218 and second target region 218′) than light reflected by second reflector 112 onto target 106 (e.g., third target region 216 and fourth target region 216′). This may be true even if there is little or no discernable difference between the reflective portions of first reflector 108 and second reflector 112. The expected particular shape of a projection of reflected light from a reflector of known location, for example, the expected particular shape of first target region 218, may be determined using known geometrical or other methods. This expected particular shape may then be used to identify in the first or second image, for example, a portion of the particular target region, e.g., first target region 218, reflected onto target 106, by a particular reflector, e.g., first reflector 108. In this manner, a different target region, e.g., target region 216, reflected onto target 106 by a different reflector, e.g., second reflector 112, may also be distinguished.

Further, a geometrical characteristic 28 of first reflector 108 may be determined. A geometrical characteristic may include, for example, a particular pattern of dirt or other fouling that is present on first reflector 108. A geometrical characteristic may also include, for example, the perimeter shape or particular curvature of first reflector 108. As another example, if first reflector 108 includes multiple mirror facets—e.g., multiple smaller mirrors assembled to approximate the shape and function of a single larger mirror—those facets may exhibit a unique configuration as compared with the configuration of the facets of a different reflector, e.g., second reflector 112. This unique configuration is a geometrical characteristic that may be determined, for example, by visual inspection, by machine vision algorithms, or by other pattern-recognition methods known in the art. This unique alignment may result from intentional manufacturing processes or from subsequent adjustment, including adjustment by animals, wind and other weather elements, or other physical impacts on first reflector 108. Referring now also to FIG. 3D, a geometrical characteristic of first reflector 108 may be manifested, for example, in a particular corresponding shape of first target region 212 (e.g., shape 214). After first reflector 108 is configured 18 to reflect light from light source 100 onto second target region 212′, the effects of the geometrical characteristic of first reflector 108 may persist, for example, as shape 214′. It will be understood that shape 214 and shape 214′ may be similar or identical in shape or may differ. The correspondence between the geometrical characteristic of first reflector 108 and the shape of the projection of the light reflected from first reflector 108 (e.g., shape 214 of first target region 212 and shape 214′ of second target region 212′) may be employed, for example, to determine the location of the target regions. For example, shape 214, which results from a geometric characteristic of first reflector 108, may be identified in the first image in order to determine the location of first target region 212 in the first image; likewise, shape 214′, which also results from a geometric characteristic of first reflector 108, may be identified in the second image in order to determine the location of second target region 212′ in the second image.

It will be understood that the method described above may also be implemented as a system or as a control system including at least one processor. As is known in the art, various systems or control systems may include a variety of computing devices which may store data and communicate with each other and other elements of the system or control system in a variety of ways. Various of the processes described may be implemented through the use of hardware or software modules in various combinations.

A number of implementations have been described. Nevertheless, it will be understood that various modifications may be made. Accordingly, other implementations are within the scope of the following claims.

What is claimed is:

1. A method of aligning a reflector with a target comprising:
receiving, at a first reflector, light from a light source;
configuring the first reflector to reflect light from the light source onto a target, illuminating the target in a first target region;
capturing a first image of the target, using an imaging device;
configuring the first reflector to reflect light from the light source onto the target, illuminating the target in a second target region;
capturing a second image of the target, using the imaging device; and
determining an alignment of the first reflector with respect to at least one of the light source and the target by, at least in part, comparing the first image and the second image.

2. The method of claim 1 further comprising:
receiving, at a second reflector, light from the light source
configuring the second reflector to reflect light from the light source onto the target, illuminating the target in a third target region;
capturing a third image of the target, using the imaging device;
configuring the second reflector to reflect light from the light source onto the target, illuminating the target in a fourth target region;
capturing a fourth image of the target, using the imaging device;
determining an alignment of the second reflector with respect to at least one of the light source and the target by, at least in part, comparing the third image and the fourth image.

3. The method of claim 1 further comprising:
determining a centroid of at least one of the first target region and the second target region.

4. The method of claim 1 further comprising: p1 identifying a fringe portion of at least one of the first target region and the second target region.

5. The method of claim 1 further comprising:
generating a vibration of the first reflector; and
determining at least one of a time to capture at least one of the first image and the second image and a location of a portion of at least one of the first target region and the second target region, based, at least in part, on the vibration of the first reflector.

6. The method of claim 1 further comprising:
determining a location of the first reflector;
determining a geometrical characteristic of the first reflector;
identifying a portion of at least one of the first target region and the second target region, based, at least in part, on at least one of the location of the first reflector and the geometrical characteristic of the first reflector.

7. The method of claim 1 wherein the imaging device comprises at least one or more of the following:
a digital camera; and
a digital video camera.

8. A system for aligning a reflector with a target comprising:
a first reflector, configured to receive light from a light source;
a target;
a processor; and
an imaging device;
wherein,
the first reflector is configured to reflect light from the light source onto the target, illuminating the target in a first target region;
the imaging device is configured to capture a first image of the target;
the first reflector is configured to reflect light from the light source onto the target, illuminating the target in a second target region;
the imaging device is configured to capture a second image of the target; and
the processor is configured to determine an alignment of the first reflector with respect to at least one of the light source and the target by, at least in part, comparing the first image and the second image.

9. The system of claim 8 further comprising:
A second reflector, configured to receive light from a light source;
wherein,
the second reflector is configured to reflect light from the light source onto the target, illuminating the target in a third target region;
the imaging device is configured to capture a third image of the target;
the second reflector is configured to reflect light from the light source onto the target, illuminating the target in a fourth target region;
the imaging device is configured to capture a fourth image of the target; and
the processor is configured to determine an alignment of the second reflector with respect to at least one of the light source and the target by, at least in part, comparing the third image and the fourth image.

10. The system of claim 8 wherein:
a centroid is determined of at least one of the first target region and the second target region.

11. The system of claim 8 wherein:
a fringe portion is identified of at least one of the first target region and the second target region.

12. The system of claim 8 wherein:
a vibration of the first reflector is generated; and
at least one of a time to capture at least one of the first image and the second image and a location of a portion at least one of the first target region and the second target region is determined, based, at least in part, on the vibration of the first reflector.

13. The system of claim 8 wherein:
a location of the first reflector is determined;
a geometrical characteristic of the first reflector is determined; and
a portion of at least one of the first target region and the second target region is identified, based, at least in part, on at least one of the location of the first reflector and the geometrical characteristic of the first reflector.

14. The system of claim 8 wherein the imaging device comprises at least one or more of the following:
a digital camera; and
a digital video camera.

15. A control system for aligning a reflector with a target, the control system comprising:
a reflector, configured to receive light from a light source;
a target;
at least one processor; and
an imaging device;
wherein
the reflector is configured to reflect light from the light source onto a target, illuminating the target in a first target region;
the imaging device is configured to capture a first image of the target;
the reflector is configured to reflect light from the light source onto the target, illuminating the target in a second target region;
the imaging device is configured to capture a second image of the target; and
the processor is configured to
determine a first alignment of a reflector with respect to at least one of the light source and the target by, at least in part, comparing the first image and the second image,
determine a deviation between the first alignment of the reflector and a target alignment of the reflector, and
configure a second alignment of the reflector, based at least in part on the deviation between the first alignment of the reflector and the target alignment of the reflector.

16. A method for aligning a reflector with a target comprising:
receiving light from a light source at a reflector;
configuring the reflector to reflect light from the light source onto a target, illuminating the target in a target region;
capturing an image of the target, using an imaging device;
determining a location of a portion the target region by, at least in part, analyzing the image;
determining a first alignment of the reflector with respect to at least one of the light source and the target, based at least in part on the location of the portion of the target region; and
configuring a second alignment of the reflector based at least in part on a deviation between the first alignment of the reflector and a target alignment of the reflector.

17. The method of claim 16 further comprising:
determining a centroid of the target region.

18. The method of claim 16 further comprising:
identifying a fringe portion of the target region.

19. The method of claim 16 further comprising:
generating a vibration of the reflector; and
determining at least one of a time to capture the image and the location of the portion of the target region, based, at least in part on the vibration of the reflector.

20. The method of claim 16 further comprising:
determining a location of the reflector;
determining a geometrical characteristic of the reflector;
identifying the portion of the target region, based at least in part on at least one of the location of the reflector and the geometrical characteristic of the reflector.

21. The method of claim 16 wherein the imaging device comprises at least one or more of the following:
a digital camera; and
a digital video camera.

22. A system for aligning a reflector with a target comprising:
a reflector, configured to receive light from a light source;
a target
at least one processor; and
an imaging device;
wherein,
the reflector is configured to reflect light from the light source onto a target, illuminating the target in a target region;
the imaging device is configured to capture an image of the target; and
the processor is configured to
determine a location of a portion the target region by, at least in part, analyzing the image;
determine a first alignment of the reflector with respect to at least one of the light source and the target, based upon, at least in part, the location of the portion of the target region; and
determine a second alignment of the reflector, based upon, at least in part, a deviation between the first alignment of the reflector and a target alignment of the reflector.

23. The system of claim 22 wherein:
a centroid of the target region is determined.

24. The system of claim 22 wherein:
a fringe portion of the target region is identified.

25. The system of claim 22 wherein:
a vibration of the reflector is generated; and
at least one of a time to capture the image and the location of the portion of the target region is determined, based at least in part on the vibration of the reflector.

26. The system of claim 22 wherein:
a location of the reflector is determined;
a geometrical characteristic of the reflector is determined; and
at least a portion of the target region is identified, based at least in part on at least one of the location of the reflector and the geometrical characteristic of the reflector.

27. The system of claim 22 wherein the imaging device comprises at least one or more of the following:
a digital camera; and
a digital video camera.
